(19) United States
(12) Patent Application Publication
(10) Pub. No.: US 2019/0147739 A1
(43) Pub. Date: May 16, 2019

(54) INFORMATION PROCESSING DEVICE

(71) Applicants: TOYOTA JIDOSHA KABUSHIKI KAISHA, Toyota-shi (JP); AISIN AW CO., LTD., Anjo-shi (JP)

(72) Inventors: Hiroaki TAKEYAMA, Nissin-shi (JP); Xin JIN, Nagoya-shi (JP); Norihiro NAKAMURA, Toyokawa-shi (JP); Hideki KASEZAWA, Okazaki-shi (JP); Kensuke TAKEUCHI, Okazaki-shi (JP); Hajime MORIKAWA, Nagoya-shi (JP); Yoko SAKURAI, Toyohashi-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 16/151,849

(22) Filed: Oct. 4, 2018

(30) Foreign Application Priority Data
Nov. 16, 2017 (JP) 2017-221306

(51) Int. Cl. G08G 1/0962; G01C 21/36; G01C 21/34

(52) U.S. Cl. CPC G08G 1/0962; G01C 21/3697; H04L 67/18; G01C 21/3655; G01C 21/3484

(57) ABSTRACT

An information processing device includes a first acquisition unit, a first output unit, a second acquisition unit, a second output unit, and a third acquisition unit. The first acquisition unit acquires current position information indicating a current position of a vehicle. The first output unit outputs traveling guidance from a relationship between a pre-set vehicle route and the current position of the vehicle. The second acquisition unit acquires content. The second output unit outputs the content acquired by the second acquisition unit. The third acquisition unit acquires road section information specifying a road section where the traveling guidance is stopped. The first output unit stops the output of the traveling guidance based on the road section information acquired by the third acquisition unit and the current position of the vehicle.

### INCORPORATION BY REFERENCE

The disclosure of Japanese Patent Application No. 2017-221306 filed on Nov. 16, 2017 including the specification, drawings and abstract is incorporated herein by reference in its entirety.

### BACKGROUND

### 1. Technical Field

The present disclosure relates to an information processing device that notifies a user of information.

### 2. Description of Related Art

A navigation device that can automatically stop guidance at an appropriate place when a driver is in a state of easily traveling home without the guidance while the driver travels on a guide route toward the home using a highway is known (for example, Japanese Unexamined Patent Application Publication No. 2009-229241 (JP 2009-229241 A)).

### SUMMARY

In the related art, it is not possible to effectively use a time after the guidance is stopped.

The disclosure provides an information processing device capable of further improving convenience when traveling guidance is performed according to a pre-set vehicle route.

An aspect of the disclosure relates to an information processing device including a first acquisition unit, a first output unit, a second acquisition unit, a second output unit, and a third acquisition unit. The first acquisition unit is configured to acquire current position information indicating a current position of a vehicle. The first output unit is configured to output traveling guidance from a relationship between a pre-set vehicle route and the current position of the vehicle. The second acquisition unit is configured to acquire content. The second output unit is configured to output the content acquired by the second acquisition unit. The third acquisition unit is configured to acquire road section information specifying a road section where the traveling guidance is stopped. The first output unit stops the output of the traveling guidance based on the road section information acquired by the third acquisition unit and the current position of the vehicle.

According to the aspect of the disclosure, the acquired content is output, and the output of the traveling guidance is stopped based on the road section information specifying the road section where the traveling guidance is stopped and the current position of the vehicle. Consequently, it is possible to effectively provide a driver with content in a state where the output of the traveling guidance is stopped while the driver travels on a familiar road section. Therefore, it is possible to further improve convenience when the traveling guidance is performed according to the pre-set vehicle route.

The information processing device according to the aspect of the disclosure may further include a specification unit configured to specify a drive load of a driver. When the drive load specified by the specification unit is high, the second output unit may stop the output of the content.

In the information processing device according to the aspect of the disclosure, the specification unit may specify the drive load of the driver based on at least one of a degree of familiarity of the driver with a road on which the vehicle travels, an external environment of the vehicle, or a drive state of the vehicle.

In the information processing device according to the aspect of the disclosure, the content may be information associated with position information. The second output unit may output the content according to the current position of the vehicle.

In the information processing device according to the aspect of the disclosure, the content may be information not associated with position information. The second output unit may output the content at a timing when the second acquisition unit acquires the content.

In the information processing device according to the aspect of the disclosure, when the output of the traveling guidance from the first output unit is not started during a period until the output of the content ends at a timing when the second output unit starts outputting the content, the second output unit may output the content.

In the information processing device according to the aspect of the disclosure, the second output unit may output an confirmation instruction to confirm a time length of the content and a possibility of outputting traveling guidance to the first output unit at the timing when the output of the content is started. The first output unit may notify the second output unit that output of traveling guidance is started when there is a possibility that the vehicle reaches a predetermined position where traveling guidance is output on the pre-set vehicle route, during a period from a timing when the confirmation instruction is received before the time length of the content elapses. The first output unit may notify the second output unit that output of traveling guidance is not started when there is no possibility that the vehicle reaches the predetermined position on the pre-set vehicle route, during the period from the timing when the confirmation instruction is received before the time length of the content elapses.

In the information processing device according to the aspect of the disclosure, the road section where the traveling guidance is stopped may include at least one of a road section near home of a driver, a road section near a destination frequently visited by a driver, or a road section where a driver frequently travels.

In the information processing device according to the aspect of the disclosure, the information processing device may be mounted on the vehicle.

In the information processing device according to the aspect of the disclosure, the information processing device may be included in a server device disposed outside the vehicle.

According to the aspects of the disclosure, it is possible to further improve the convenience when the traveling guidance is performed according to the pre-set vehicle route.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram showing a configuration of a vehicle system according to a first embodiment;

FIG. 2 is a block diagram showing a configuration of a server device of FIG. 1;

FIG. 3 is a diagram for describing an example of a situation where content is output while a vehicle travels along a set route that is set by the server device of FIG. 1;

FIG. 4 is a flowchart showing traveling guidance processing in the server device of FIG. 1; and

FIG. 5 is a block diagram showing a configuration of an on-vehicle device according to a second embodiment.

### DETAILED DESCRIPTION OF EMBODIMENTS

### First Embodiment

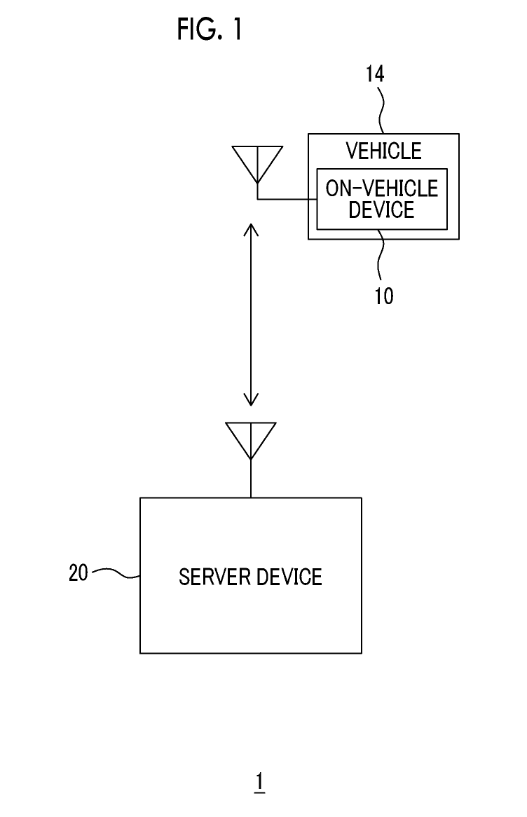

FIG. 1 is a block diagram showing a configuration of a vehicle system 1 according to a first embodiment. The vehicle system 1 includes an on-vehicle device 10 and a server device 20. Here, an example that one on-vehicle device 10 is provided is described for clearness of the description, but the vehicle system 1 can include a plurality of on-vehicle devices 10.

The on-vehicle device 10 is a car navigation device mounted on a vehicle 14 which is an automobile or the like. The on-vehicle device 10 performs wireless communication with the server device 20. A standard of the wireless communication is not particularly limited and includes, for example, 3G (third generation mobile communication system), 4G (fourth generation mobile communication system), or 5G (fifth generation mobile communication system). The on-vehicle device 10 may perform the wireless communication with the server device 20 through a base station (not shown).

The on-vehicle device 10 periodically acquires current position information of a host vehicle (hereinafter, simply referred to also as “current position information”) and vehicle information, and transmits the current position information and the vehicle information to the server device 20. Examples of the vehicle information include speed information of the host vehicle, acceleration information of the host vehicle, and remaining gas amount information of the host vehicle. Information for identifying the vehicle 14 which is a transmission source is attached to the current position information and the vehicle information.

Frequency of acquiring the current position information and the vehicle information and frequency of transmitting the current position information and the vehicle information can be appropriately determined by an experiment or the like. The current position information is acquired from, for example, a global positioning system (GPS) receiver (not shown) provided on the vehicle 14. The speed information, the acceleration information, and the remaining gas amount information are acquired from, for example, various sensors (not shown) provided on the vehicle 14.

The on-vehicle device 10 can accept input of route search information for performing a route search from a driver. Example of the route search information includes a destination. The on-vehicle device 10 transmits the input route search information to the server device 20.

The server device 20 is installed, for example, in a data center and functions as an information processing device configured to process the information transmitted from the on-vehicle device 10 to execute the route search, traveling guidance, and content provision.

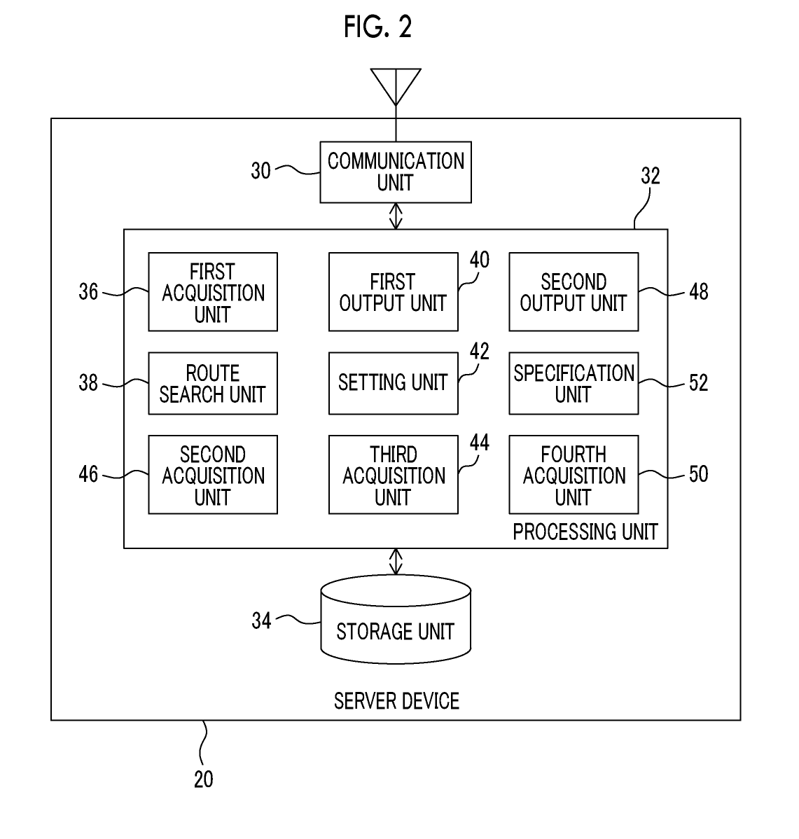

FIG. 2 is a block diagram showing a configuration of the server device 20 of FIG. 1. The server device 20 includes a communication unit 30, a processing unit 32, and a storage unit 34. The processing unit 32 includes a first acquisition unit 36, the route search unit 38, a first output unit 40, a setting unit 42, a third acquisition unit 44, a second acquisition unit 46, a second output unit 48, a fourth acquisition unit 50, and a specification unit 52.

The communication unit 30 performs the wireless communication with the on-vehicle device 10. The communication unit 30 receives the current position information, the vehicle information, and the route search information of the vehicle 14 from the on-vehicle device 10. The communication unit 30 outputs the current position information, the vehicle information, and the route search information of the vehicle 14 to the first acquisition unit 36.

The first acquisition unit 36 acquires the current position information, the vehicle information, and the route search information of the vehicle 14 received from the communication unit 30. The first acquisition unit 36 outputs the current position information, the vehicle information, and the route search information of the vehicle 14 to the storage unit 34. The storage unit 34 stores the current position information, the vehicle information, and the route search information of the vehicle 14 acquired by the first acquisition unit 36. The current position information and the vehicle information stored in the storage unit 34 are sequentially updated, and the latest current position information and the latest vehicle information are held. The storage unit 34 holds a traveling history of the vehicle 14 which is a history of a transition of the current position information. The storage unit 34 stores map data in advance.

The route search unit 38 searches a route from a departure place to the destination based on the route search information and the map data stored in the storage unit 34 to set a route for the traveling guidance among the searched routes. The route search unit 38 causes the storage unit 34 to store the pre-set vehicle route to be set (hereinafter, referred to as a pre-set route). Since a known technique can be used for the route search and the route setting, a further description will be omitted. The route search unit 38 causes the storage unit 34 to store a destination search history and the number of settings of the destination based on the route search information.

The first output unit 40 outputs the set route stored in the storage unit 34 to the on-vehicle device 10 through the communication unit 30. The first output unit 40 outputs the traveling guidance for guiding traveling along the set route to the on-vehicle device 10 through the communication unit 30 from a relationship between the set route stored in the storage unit 34 and a current position of the vehicle 14. Specifically, when the current position of the vehicle 14 reaches a predetermined position of the set route, the first output unit 40 outputs the traveling guidance corresponding to the predetermined position to the on-vehicle device 10 through the communication unit 30. The predetermined position is included in the set route in advance. Example of the traveling guidance includes “turn right in 300 meters” which is output at 300 meters before an intersection where the driver is requested to turn right on the set route. The traveling guidance is output by a voice in the on-vehicle device 10. The traveling guidance may include, for example, guidance on construction work or congestion on the set route. Since a known technique can be used for the output of the traveling guidance, a further description will be omitted.

The setting unit 42 sets a road section where the traveling guidance is stopped and causes the storage unit 34 to store road section information for specifying the road section. The road section where the traveling guidance is stopped is a road section near home of the driver, a road section near a destination frequently visited by the driver, a road section where the driver frequently travels, or the like. The road section near the home of the driver is set to a range within a predetermined distance from the home based on a position of the home that the driver inputs to the on-vehicle device 10. The road section near the destination frequently visited by the driver is set to a range within a predetermined distance from the destination visited by the driver the predetermined number of times or more based on the number of settings of the destination stored in the storage unit 34. The road section where the driver frequently travels is set to a road section where the driver travels the predetermined number of times or more based on the map data and the traveling history stored in the storage unit 34.

The third acquisition unit 44 acquires the road section information for specifying the road section where the traveling guidance is stopped from the storage unit 34. The first output unit 40 stops the output of the traveling guidance based on the road section information acquired by the third acquisition unit 44 and the current position of the vehicle 14. Specifically, when the current position of the vehicle 14 is located within the road section specified by the road section information, the first output unit 40 stops the output of the traveling guidance.

The second acquisition unit 46 acquires the content from a content server (not shown) or the like through the Internet. The second acquisition unit 46 outputs the acquired content to the storage unit 34. The storage unit 34 stores the content output from the second acquisition unit 46.

The content is information associated with position information or information not associated with the position information. Examples of the information associated with position information include information on a fair in a restaurant associated with the position information of the restaurant and information on a new store or facility associated with the position information of the new store or facility. An example of the information not associated with position information includes various pieces of news including sports news such as baseball or soccer, social news, economic news, and the like.

The second output unit 48 outputs the content acquired by the second acquisition unit 46 to the on-vehicle device 10 through the communication unit 30. When content is the information associated with the position information, the second output unit 48 outputs the content according to the current position of the vehicle 14. Specifically, when the current position of the vehicle 14 becomes the position associated with content, the second output unit 48 outputs the content. When content is the information not associated with the position information, the second output unit 48 outputs the content at a timing when the second acquisition unit 46 acquires the content.

When the output of the traveling guidance from the first output unit 40 is not started during a period until the output of the content ends at a timing when the output of the content is started, the second output unit 48 outputs the content. When the output of the traveling guidance from the first output unit 40 is started during the period until the output of the content ends at the timing when the output of the content is started, the second output unit 48 does not output the content. In the case described above, after the output of the traveling guidance ends, the second output unit 48 determines again whether the output of the traveling guidance from the first output unit 40 is not started during a period until the output of the content ends at the timing when the output of the content is started. As described above, the output of the traveling guidance has a priority over the output of the content.

Specifically, the second output unit 48 outputs an instruction to confirm a time length of content and a possibility of outputting traveling guidance to the first output unit 40 at the timing when the output of the content is started. When there is a possibility that the current position of the vehicle 14 reaches the predetermined position where the traveling guidance is output on the set route during a period from a timing of receiving the confirmation instruction before the time length of the content elapses based on a current speed of the vehicle 14, the first output unit 40 notifies the second output unit 48 that the output of the traveling guidance is started. When there is no possibility that the current position of the vehicle 14 reaches the predetermined position of the set route during the period from the timing of receiving the confirmation instruction before the time length of the content elapses, the first output unit 40 notifies the second output unit 48 that the output of the traveling guidance is not started.

The second output unit 48 may select content that matches a preference of the driver among the contents acquired by the second acquisition unit 46 and may output the selected content. The second output unit 48 specifies the preference of the driver from a type of a searched destination based on the destination search history stored in the storage unit 34. The second output unit 48 may specify the preference of the driver based on a browsing history of websites acquired from a mobile terminal such as a smartphone held by the driver.

The fourth acquisition unit 50 periodically acquires congestion information, weather information, and brightness information from various servers (not shown) or the like through the Internet. The fourth acquisition unit 50 outputs the acquired congestion information, weather information, and brightness information to the storage unit 34. The storage unit 34 stores the congestion information, the weather information, and the brightness information output from the fourth acquisition unit 50. The congestion information, the weather information, and the brightness information stored in the storage unit 34 are sequentially updated, and the latest congestion information, weather information, and brightness information are held. When the on-vehicle device 10 can acquire the weather information and the brightness information using sensors, the weather information and the brightness information can be acquired by the on-vehicle device 10.

The specification unit 52 specifies a drive load of the driver (hereinafter, simply referred to also as a “drive load”) based on at least any one of a degree of familiarity of the driver with a road during traveling, an external environment of the vehicle 14, or a vehicle state. The external environment of the vehicle 14 includes the weather, the brightness, a road shape, a degree of congestion, and the like. The vehicle state includes the speed, the acceleration, the remaining gas amount, and the like.

Specifically, the specification unit 52 specifies the drive load lower as the number of times of traveling on the road during traveling is larger based on the traveling history and the current position information stored in the storage unit 34. The reason is that the more the number of times of traveling on the road, the more the driver is familiar with the road.

The specification unit 52 specifies the drive load higher when the weather at the current position of the vehicle 14 is rain, snow, or the like than when the weather is sunny or cloudy based on the weather information and the current position information stored in the storage unit 34.

The specification unit 52 specifies the drive load higher as the brightness at the current position of the vehicle 14 is darker based on the brightness information and the current position information stored in the storage unit 34. That is, the specification unit 52 specifies the drive load higher in the nighttime, early morning, evening, or the like than in the daytime.

The specification unit 52 specifies the drive load higher when a road shape during traveling is a curve than when the road shape is a straight line based on the map data and the current position information stored in the storage unit 34. The specification unit 52 specifies the drive load higher when the road during traveling includes a plurality of lanes on one side than when the road includes one lane on one side based on the pieces of information described above.

The specification unit 52 specifies the drive load higher when the current position of the vehicle 14 is at a position just before the right turn position or the left turn position on the set route than when the current position is far from the right turn position or the left turn position based on the set route and the current position information stored in the storage unit 34.

The specification unit 52 specifies the drive load higher as the degree of congestion on the road during traveling is higher based on the congestion information and the current position information stored in the storage unit 34.

The specification unit 52 specifies the drive load of the driver higher as the speed of the vehicle 14 is higher based on the vehicle information stored in the storage unit 34. The specification unit 52 specifies the drive load higher as the acceleration of the vehicle 14 is higher based on the vehicle information. The specification unit 52 specifies the drive load higher when the remaining gas amount is less than a predetermined amount than when the remaining gas amount is equal to or larger than the predetermined amount based on the vehicle information.

When the drive load specified by the specification unit 52 is higher than a predetermined value, the second output unit 48 stops the output of the content. The predetermined value can be appropriately determined by the experiment or the like.

Return to FIG. 1. The on-vehicle device 10 receives the set route, the traveling guidance, and the content which are transmitted from the communication unit 30.

The on-vehicle device 10 displays the set route as an image and outputs the traveling guidance and the content as the voice based on the received information.

In terms of hardware, the configuration described above can be realized by a central processing unit (CPU) of any computer, a memory, another large-scale integration (LSI). In terms of software, the configuration can be realized by a program loaded in the memory. Here, functional blocks realized by cooperation between the hardware and the software are depicted. Therefore, those skilled in the art understand that the functional blocks can be realized in various forms by the hardware alone, the software alone, or a combination of the above.

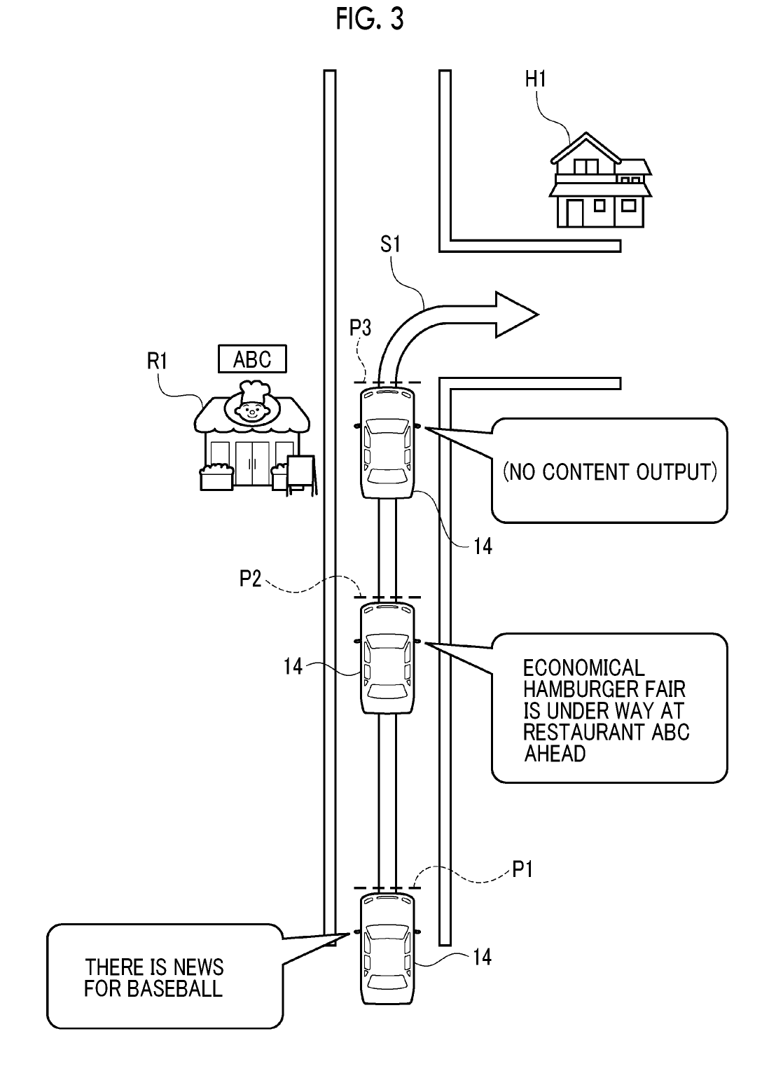

An example of the output of the content will be described with reference to FIG. 3. FIG. 3 is a diagram for describing an example of a situation where content is output while the vehicle 14 travels along a set route S1 set by the server device 20 of FIG. 1. In FIG. 3, a situation is assumed that the destination of the set route S1 is a home H1, and the vehicle 14 is located in the road section where the traveling guidance near the home H1 is stopped. Thus, the output of the traveling guidance is stopped.

At a position P1, the drive load is low, and content “There is news for baseball” is output. The content is the information not associated with the position information and is output at an acquired timing. The content is selected based on the preference of the driver.

At a position P2, the drive load is low, and content “An economical hamburger fair is under way at the restaurant ABC ahead” is output. The content is the information associated with the position information and is output when the current position of the vehicle becomes the position P2 associated with the content. The position P2 is a position in front of a restaurant R1 named “ABC”.

At a position P3, the drive load is high since the position is just before the right turn position, and the content is not output.

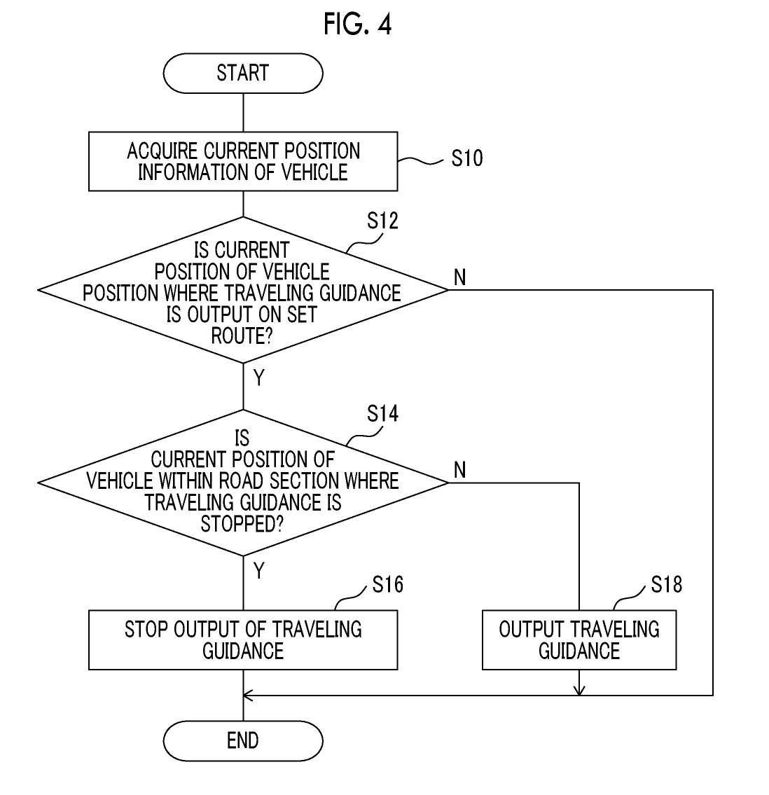

The overall operation of the vehicle system 1 with the configuration described above will be described. FIG. 4 is a flowchart showing traveling guidance processing in the server device 20 of FIG. 1. The processing of FIG. 4 is periodically repeated. The first acquisition unit 36 acquires the current position information of the vehicle 14 (S10). When the current position of the vehicle is not a position where the traveling guidance is output on the set route (N in S12), the processing ends. When the current position of the vehicle is the position where the traveling guidance is output on the set route (Yin S12) and the current position of the vehicle is within the road section where the traveling guidance is stopped (Y in S14), the output of the traveling guidance is stopped (S16) and the processing ends. In step S14, when the current position of the vehicle is not within the road section where the traveling guidance is stopped (N in S14), the traveling guidance is output (S18) and the processing ends.

According to the embodiment described above, the acquired content is output, and the output of the traveling guidance is stopped based on the road section information for specifying the road section where the traveling guidance is stopped and the current position of the vehicle. Therefore, it is possible to effectively provide the driver with the content in a state where the output of the traveling guidance is stopped while the driver travels on the familiar road section. Thus, it is possible to effectively use a time after the traveling guidance is stopped. Therefore, it is possible to further improve convenience when the traveling guidance is performed according to the set route.

Since the output of the content is stopped when the drive load of the driver is high, it is possible to suppress a situation in which the driver feels annoyed due to the content when the driver desires to concentrate on the driving.

Since content is information associated with the position information and the content is output according to the current position of the vehicle, it is possible to provide information on the store, the facility, or the like near the current position at an appropriate timing.

Content is information not associated with the position information, and the content is output at a timing when the second acquisition unit acquires the content. Therefore, it is possible to provide news or the like even though there is no information on the store near the current position or the like.

When the output of the traveling guidance is not started during the period until the output of the content ends at the timing when the output of the content is started, the content is output. Therefore, it is possible to suppress the overlap between the output of the content and the output of the traveling guidance and make it easy for the driver to hear the traveling guidance and the content. It is possible to perform the traveling guidance at an appropriate timing in preference to the content.

### Second Embodiment

A second embodiment differs from the first embodiment in that most of the processing of the server device 20 in the first embodiment is performed by the on-vehicle device 10. In the following description, differences from the first embodiment will be mainly described.

The server device 20 receives the current position information from the on-vehicle device 10 and stores the received current position information. Similarly to the first embodiment, the server device 20 acquires and stores content from the content server through the Internet. When content is information associated with the position information, the server device 20 transmits the content to the on-vehicle device 10 according to the current position of the vehicle 14. When content is information not associated with the position information, the server device 20 transmits the content to the on-vehicle device 10 at a timing when the content is acquired.

Similarly to the first embodiment, the server device 20 periodically acquires and stores the congestion information, the weather information, and the brightness information from the various servers or the like through the Internet. The server device 20 transmits the congestion information, the weather information, and the brightness information which are associated with the current position of the vehicle 14 to the on-vehicle device 10.

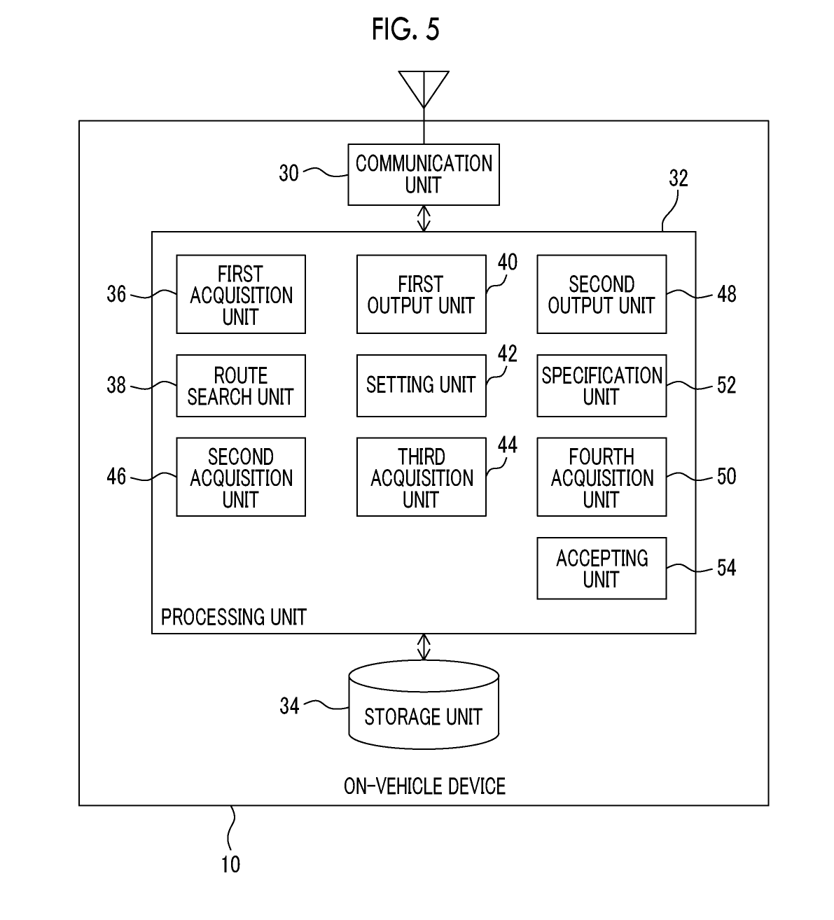

FIG. 5 is a block diagram showing a configuration of the on-vehicle device 10 according to the second embodiment. The on-vehicle device 10 functions as the information processing device. The on-vehicle device 10 includes the communication unit 30, the processing unit 32, and the storage unit 34. The processing unit 32 includes the first acquisition unit 36, the route search unit 38, the first output unit 40, the setting unit 42, the third acquisition unit 44, the second acquisition unit 46, the second output unit 48, the fourth acquisition unit 50, the specification unit 52, and an accepting unit 54.

The first acquisition unit 36 acquires the current position information of the vehicle 14 from the GPS receiver (not shown), acquires the vehicle information from various sensors (not shown), and acquires the route search information from the accepting unit 54 configured to accept operation input by the driver. The communication unit 30 transmits the acquired current position information of the vehicle 14 to the server device 20.

The storage unit 34 stores pieces of information similar to the pieces of information in the first embodiment. The route search unit 38 has functions similar to the functions in the first embodiment. The first output unit 40 outputs the set route as the image and outputs the traveling guidance by the voice.

The setting unit 42 and the third acquisition unit 44 have functions similar to the functions in the first embodiment. Similarly to the first embodiment, the first output unit 40 stops the output of the traveling guidance based on the road section information acquired by the third acquisition unit 44 and the current position of the vehicle 14.

The second acquisition unit 46 acquires content from the server device 20 through the communication unit 30. The storage unit 34 stores the content acquired by the second acquisition unit 46.

The second output unit 48 outputs the content acquired by the second acquisition unit 46 as the voice at the timing when the second acquisition unit 46 acquires the content. When content is information associated with the position information, the server device 20 transmits the content to the on-vehicle device 10 according to the current position of the vehicle 14. Accordingly, the second output unit 48 outputs the content according to the current position of the vehicle 14.

Similarly to the first embodiment, when the output of the traveling guidance from the first output unit 40 is not started during a period until the output of the content ends at the timing when the output of the content is started, the second output unit 48 outputs the content. Similarly to the first embodiment, the second output unit 48 may select content that matches the preference of the driver among the contents acquired by the second acquisition unit 46 and may output the selected content.

The fourth acquisition unit 50 periodically acquires the congestion information, the weather information, and the brightness information which are associated with the current position from the server device 20 through the communication unit 30. When the weather information and the brightness information can be acquired by sensors of the vehicle 14, the weather information and the brightness information may be acquired by the sensors. The fourth acquisition unit 50 causes the storage unit 34 to store the acquired congestion information, weather information, and brightness information.

The specification unit 52 has functions similar to the functions in the first embodiment. Similarly to the first embodiment, the second output unit 48 stops the output of the content based on the drive load specified by the specification unit 52.

According to the second embodiment, a degree of freedom of the configuration of the vehicle system 1 can be enhanced after obtaining the effects of the first embodiment.

The embodiments are merely examples, and those skilled in the art understand that various modifications are possible in a combination of each component and each processing process, and such modifications are within the scope of the disclosure.

What is claimed is:

1. An information processing device comprising:
a first acquisition unit configured to acquire current position information indicating a current position of a vehicle;
a first output unit configured to output traveling guidance from a relationship between a pre-set vehicle route and the current position of the vehicle;
a second acquisition unit configured to acquire content;
a second output unit configured to output the content acquired by the second acquisition unit; and
a third acquisition unit configured to acquire road section information specifying a road section where the traveling guidance is stopped,
wherein the first output unit stops the output of the traveling guidance based on the road section information acquired by the third acquisition unit and the current position of the vehicle.

2. The information processing device according to claim 1, further comprising a specification unit configured to specify a drive load of a driver,
wherein when the drive load specified by the specification unit is high, the second output unit stops the output of the content.

3. The information processing device according to claim 2, wherein the specification unit specifies the drive load of the driver based on at least one of a degree of familiarity of the driver with a road on which the vehicle travels, an external environment of the vehicle, or a drive state of the vehicle.

4. The information processing device according to claim 1, wherein:
the content is information associated with position information; and
the second output unit outputs the content according to the current position of the vehicle.

5. The information processing device according to claim 1, wherein:
the content is information not associated with position information; and
the second output unit outputs the content at a timing when the second acquisition unit acquires the content.

6. The information processing device according to claim 1, wherein when the output of the traveling guidance from the first output unit is not started during a period until the output of the content ends at a timing when the second output unit starts outputting the content, the second output unit outputs the content.

7. The information processing device according to claim 6, wherein:
the second output unit outputs a confirmation instruction to confirm a time length of the content and a possibility of outputting traveling guidance to the first output unit at the timing when the output of the content is started;
the first output unit notifies the second output unit that output of traveling guidance is started when there is a possibility that the vehicle reaches a predetermined position where traveling guidance is output on the pre-set vehicle route, during a period from a timing when the confirmation instruction is received before the time length of the content elapses; and
the first output unit notifies the second output unit that output of traveling guidance is not started when there is no possibility that the vehicle reaches the predetermined position on the pre-set vehicle route, during the period from the timing when the confirmation instruction is received before the time length of the content elapses.

8. The information processing device according to claim 1, wherein the road section where the traveling guidance is stopped includes at least one of a road section near home of a driver, a road section near a destination frequently visited by a driver, or a road section where a driver frequently travels.

9. The information processing device according to claim 1, wherein the information processing device is mounted on the vehicle.

10. The information processing device according to claim 1, wherein the information processing device is included in a server device disposed outside the vehicle.
